(19) United States
(12) Patent Application Publication
(10) Pub. No.: US 2005/0132246 A1
(43) Pub. Date: Jun. 16, 2005

(54) Method and system for adjusting time settings

(75) Inventors: Joseph E. Schmalz, League City, TX (US); Fabian F. Rojas, Houston, TX (US); Martyn J. Riley, Scotland (GB); Andrew M. Ray, Scotland (GB)

Correspondence Address: BAKER BOTTS, LLP, 910 LOUISIANA, HOUSTON, TX, 77002-4995, US

(73) Assignees: Halliburton Energy Services, Inc.; 4i2i Communications, Ltd.

(21) Appl. No.: 10/724,801

(22) Filed: Dec. 1, 2003

(51) Int. Cl. G06F 1/04

(52) U.S. Cl. 713/502

(57) ABSTRACT

Embodiments of methods, computer programs, and systems for adjusting time settings according to the invention are disclosed. One embodiment of the invention of the computer system includes a first processor (140) that maintains a first time as well as a communication medium (115) coupled to the first processor (140). The computer system also includes a second processor (125) that maintains a second time and is coupled to the communications medium (115). The first processor (140) is adapted to receive a first message and the second processor (125) is adapted to receive a second message. A first time is recorded when the first processor (140) receives the first message. A second time is recorded when the second processor (125) receives the second message. The first processor (140) is adapted to send a third message to the second processor (125). The second processor (125) is adapted to send a fourth message to the first processor (140) that includes information indicative of the recorded second time. Upon receipt of the fourth message, the first time is set based at least in part on the sum of the recorded second time and the roundtrip time for the third and fourth messages.

### BACKGROUND

The present invention relates to the field of communications. In particular, the invention relates to a method and system for adjusting time settings.

Information handling devices, such as electronic processors, can include or communicate with one or more components used to provide a measurement of elapsed time to a greater or lesser degree of accuracy. When information is received, processed, or transmitted by an information handling device, the time indicated by those components can be associated with the information. In some situations, the times associated with sets of information are used to match that information. For example, a first information handling device could associate times with measurements of a first type, while a second information handling device associates times with measurements of a second type. If the measurements of the first type are associated with measurements of the second type based on the measurements having been taken in some specified time relationship, it can be useful for the information handling devices to have adjusted their time settings into a particular relationship.

### BRIEF DESCRIPTION OF THE DRAWINGS

FIG. 1 is a block diagram of one embodiment of the invention of a system for adjusting time settings.

FIG. 2A is a communication flow diagram to implement a method to adjust time settings according to one embodiment of the invention.

FIG. 2B is a communication flow diagram to implement a method to adjust time settings according to one embodiment of the invention.

FIG. 3 is a flowchart to implement a method to adjust time settings according to one embodiment of the invention.

FIG. 4 is a flowchart to implement a method to adjust time settings according to one embodiment of the invention.

### DETAILED DESCRIPTION

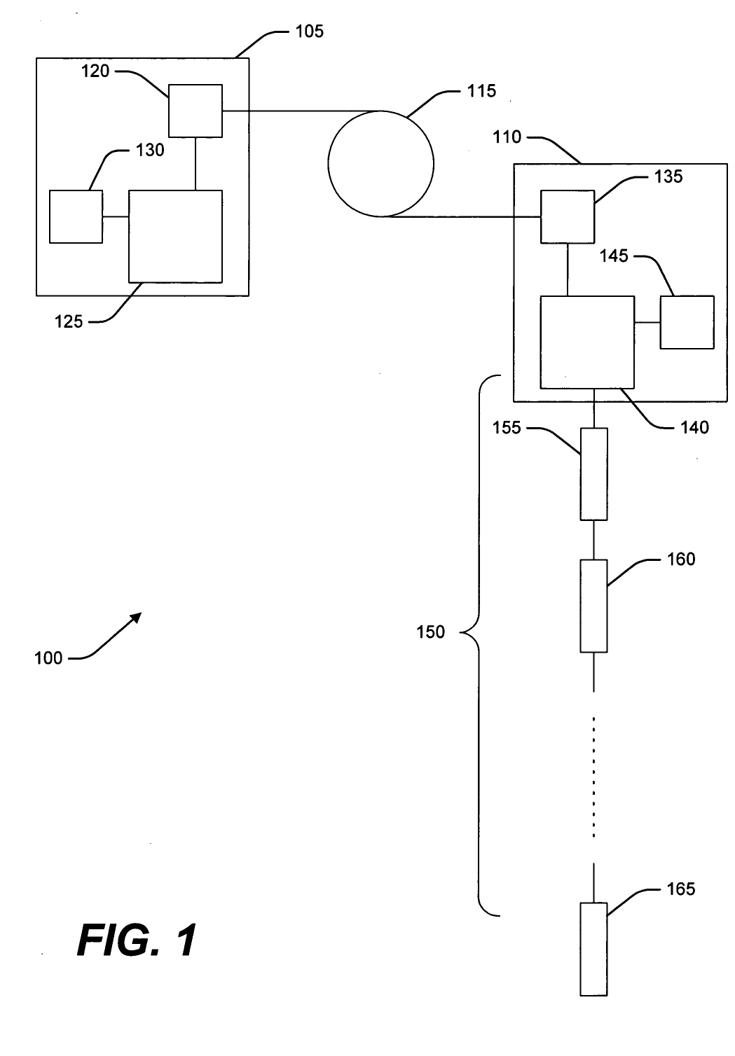

One embodiment of the invention of a system of adjusting relative time settings is illustrated in FIG. 1. While the embodiment of the invention is shown for a wireline system in a well for petroleum products, the system for could also be used in other environments for adjusting time settings. A first information handling device 110 is disposed downhole and coupled to a second information handling device 105 located at the surface of the well by a communications medium 115. The communications medium can be an Asymmetric Digital Subscriber Line (ADSL) extending along a wireline connection running into the well. In one embodiment of the invention, the ADSL has significantly higher communication capacity in the direction from devices located downhole to the surface than in the other direction. For example, the ADSL can transmit 800,000 bits of information a second (800 kb/s) toward the surface, while only carrying 40 kb/s downhole. The greater capacity in the uplink direction can be useful when devices deployed within the well measure significant amounts of data and attempt to transmit that data to the surface.

The second information handling device 105 includes an ADSL modem 120, coupled to the communications medium 115. The second information handling device 105 also includes a processor 125 and a clock 130. The clock 130 maintains a time that can be accessed and adjusted by a processor, e.g. 125. The ADSL modem 120 may reformat messages received from the communications medium 115 for the processor 125. The ADSL modem 120 may also reformat messages received from the processor 125 for the communications medium 115. In one embodiment of the invention, the processor 125 tracks the depth of the devices on the wireline in the well and stores the depth information along with the corresponding time as determined from the clock 130.

The first information handling device 110 includes an ADSL modem 135, coupled to the communications medium 115. The first information handling device 110 also includes a processor 140 and a clock 145. The clock 145 maintains a time that can be accessed and adjusted by a processor, e.g., processor 140. The ADSL modem 135 may reformat messages received from the communications medium 115 for the processor 140. The ADSL modem 135 also may reformat messages received from the processor 140 for the communications medium 115. In one embodiment of the invention, the processor 140 receives messages from a plurality of tools, for example downhole tools 155, 160, and 165. The tools communicate with the processor 140 through, for example, a network 150. The network 150 can be a symmetric network such as 10 MB/s Ethernet. Each tool 155, 160, and 165 can include a clock and can send data, e.g., formation measurements, to the processor 140 in packets that include the time that the measurement was taken according to the clock associated with the tool that took the measurement. Each clock associated with the tools 155, 160, and 165 can be adjusted to be in time with the clock 145 using a synchronization method suitable for a symmetric network. In an alternate embodiment, the tools 155, 160, and 165 can be coupled to the processor 140 by an asymmetric communications medium and an embodiment of the invention disclosed herein can be used to adjust the time settings.

In one embodiment of the invention, packets or messages sent by the tools 155, 160, and 165 to the downhole processor 140 are sent to surface processor 125 by way of ADSL modem 135, communications medium 115, and ADSL modem 120. Differences between the clocks of the tools 155, 160, and 165 and clock 130 can result in incorrect matching of measurements, e.g., formation measurements, taken by tools to the depth of the tools in the well. Greater differences in time settings may result in greater errors in depth. In other words, a measurement taken at a particular depth may be recorded as having been taken at a different depth depending upon the amount of skew between the clocks associated with the tools and surface clock 130. Differences in time settings can also cause problems in situations that require coordination of sensing conditions and controlling processes. For example, a refinery can include a control room that receives measurements based on which process control changes are implemented. Sensors remote from the control room, e.g., outside the control room, can provide the measurements. Differences in the time settings of processors that time stamp those measurements can lead to inefficient or dangerous failures to control processes in accordance to the actual conditions under which those processes are being performed.

Wireline logging includes taking measurements from instruments placed at various positions in the wellbore to better understand the characteristics of the formations that surround the wellbore. The instruments are able to take measurements at different depths more quickly if they are moved quickly through the wellbore and the cost of wireline logging can be reduced by obtaining the necessary information while minimizing the time that instruments are run. The instruments can be moved more quickly, while maintaining a particular maximum depth error for the measurements, if the depth at which a particular measurement was taken can be calculated more accurately because the various clocks in the system are kept in better alignment.

In one embodiment of the invention, the processors 125 and 140 receive messages from their respective ADSL modems 120 and 135. Those messages can be uniquely identified and can be sent at the same time or at different times wherein the difference in time is known. In one embodiment of the invention, the ADSL modems 120 and 135 can send messages to their respective processors 125 and 140 at a time wherein the difference in time is x. In response to receiving the corresponding message, each processor 125 and 140 records the time setting of its clock (e.g., processor 125 records the time of clock 130). Thereafter, a processor, for example the downhole processor 140 or the surface processor 125, sends a message to the other processor that includes the recorded time. That message can also include the identifier of the original message received from the ADSL modem. The processor receiving the message can check the identifier and return the time that it recorded when it received a message from its ADSL modem having that identifier. In an alternate embodiment of the invention, the processor receiving the message can use its recorded time and the recorded time of the sending processor (obtained from the message received from the sending processor) to determine a difference that is sent to the other processor in any format. The processor receiving this second message can then adjust its clock to the sum of the time recorded by the other processor and the round trip time, which can be calculated by determining the difference between the time that the second message was received and the time initially recorded. Resetting the time in a single change can be referred to as jamming the time of one processor into another. In an alternate embodiment of the invention, a correction is applied at a regular interval. The difference between the times can be divided into subparts that are applied at regular intervals between the exchange of messages. For example, if messages are exchanged every second, the difference between times can be divided by ten to calculate a correction that is applied every tenth of a second.

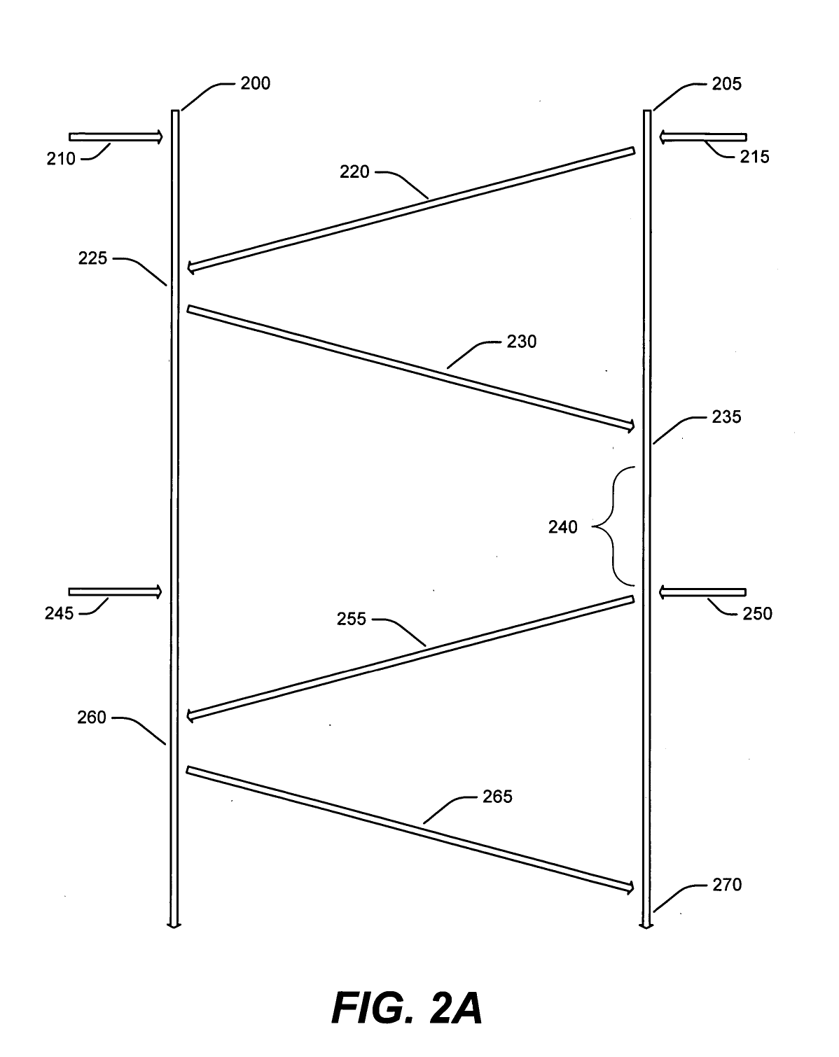

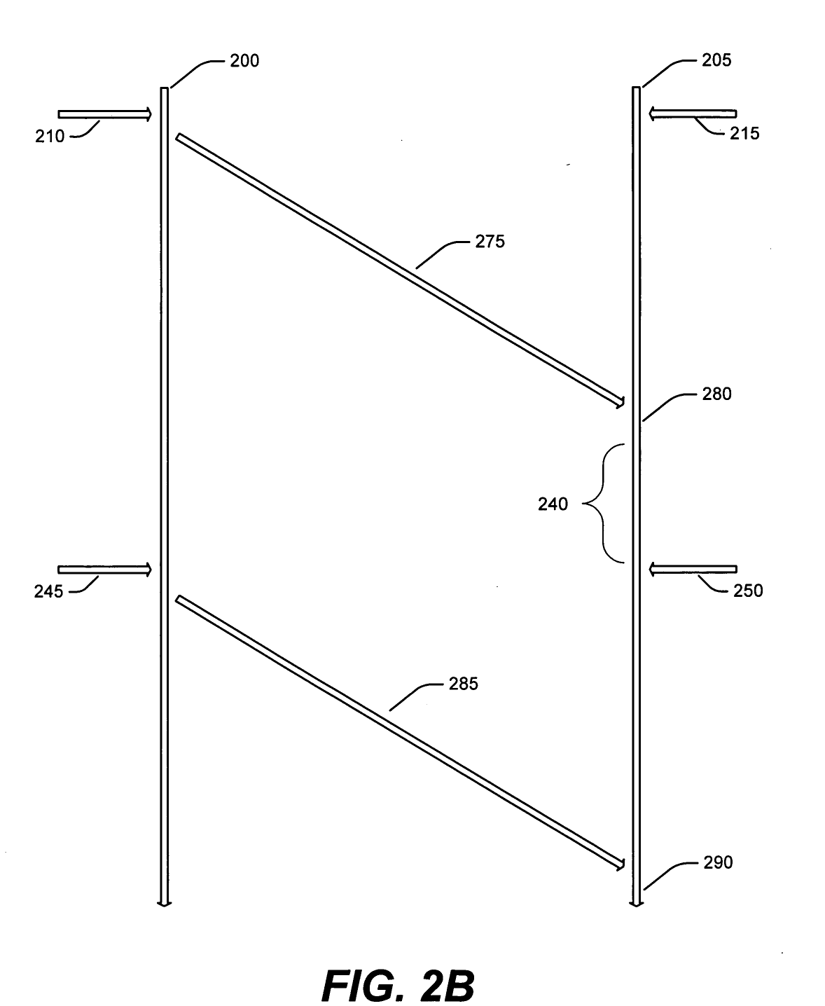

FIG. 2A is a communication flow diagram to implement a method to adjust time settings according to one embodiment of the invention. A second message 210 is received at a second processor 200 and a first message 215 is received at a first processor 205. In one embodiment of the invention the messages 210 and 215 are received within some predetermined interval of each other. In one embodiment of the invention the messages 210 and 215 include an identifier that is the same for both messages, or messages that are otherwise correlatable. The first processor 205 sends a message 220 to the second processor 200. The message 220 can include the time at which the first processor 205 received message 215. Message 220 can also include an identifier of message 215. Message 220 may be the same as message 215, but need not be. The second processor 200 receives message 220 and can check at 225 the identifier included in message 220 if there is one. The second processor 200 then prepares a message 230 including the time recorded when message 210 was received. Message 230 may be the same as message 220 with an appended time, but need not be. The first processor 205 receives message 230 and at 235 sets its time to the time of the second processor 200 when message 210 was received plus the roundtrip time of messages 220 and 230. In one embodiment of the invention, the first processor 205 calculates a new time based at least in part on (1) a known difference in time between the arrival times of the first message 215 and the second message 210, (2) the time that the second processor 200 received message 210, and (3) the roundtrip time of the inter-processor messages 220 and 230.

After the time of the first processor 205 has been set as a result of the exchange of messages, a delay 240 can occur before a new time adjustment process begins. During that delay 240, the clocks of the two processors can drift apart. For example, crystals used in clocks can have inherent differences and different amounts of heat experienced by the two clocks can also vary their recording of time. The delay between adjustments can be much greater than the roundtrip time of messages 220 and 230.

After the delay 240, new messages 245 and 250 are received and the times of reception are recorded. The first processor's time of reception is again sent at 255. At 260, the second processor 200 receives the time of reception and compares it to the time that it recorded. Based on that comparison and the times previously recorded at 210 and 215, the second processor determines a correction, for example a correction could be a tenth of the difference between the times of reception to be applied ten times, for the first processor 205 to be applied one or more times. That correction is sent to the first processor 205 in a message 265. The first processor 205 applies the correction beginning at 270 after the message is received. In an alternate embodiment of the invention, the correction is a portion of the difference between the recorded times that is applied to adjust the time of the first processor 205 on a regular basis until the adjustments equal the difference. In one embodiment of the invention, message 265 contains the time recorded by the second processor 200 and the first processor 205 calculates the correction beginning at 270.

FIG. 2B is a communication flow diagram to implement a method to adjust time settings according to one embodiment of the invention. A second message 210 is received at a second processor 200 and a first message 215 is received at a first processor 205. In one embodiment of the invention the messages 210 and 215 are received within some predetermined interval of each other. In one embodiment of the invention the messages 210 and 215 include an identifier that is the same for both messages. The second processor 200 sends a message 275 to the first processor 205. The message 275 includes the time at which the second processor 200 received message 210. Message 275 can also include an identifier of message 210. The first processor 205 receives message 275 and can check at 280 the identifier included in message 275 if there is one and compare it to the identifier of message 215. In one embodiment of the invention, the first processor 205 calculates a new time based at least in part on (1) a known difference in time between the arrival times of the first message 215 and the second message 210, (2) the time of the second processor 200 when it received message 210, and (3) the difference between the times of the first processor 205 when it received message 215 and when it received message 275.

After the time of the first processor 205 has been set, a delay 240 can occur before a new time adjustment process begins. During that delay 240, the clocks of the two processors can drift apart. For example, crystals used in clocks can have inherent differences and different amounts of heat experienced by the two clocks can also vary their recording of time. The delay between adjustments can be much greater than the transmission time of message 275.

After the delay 240, new messages 245 and 250 are received and the times of reception are recorded. The second processor's time of reception for message 245 is sent in message 285. At 290, the first processor 205 receives the second processor's time of reception in message 285 and compares it to the time that it recorded. Based on that comparison the first processor determines a correction, for example a correction could be a tenth of the difference between the times of reception to be applied ten times, for the first processor to be applied one or more times. The first processor 205 then applies the correction beginning at 290. In another embodiment, the first processor 205 keeps the last recorded time of the second processor 200 (i.e., when message 210 was received) and its own last recorded time (i.e., when message 215 was received). The first processor compares the difference between the second processor's last recorded time and current recorded time (i.e., when message 245 was received) to the difference between its own last recorded time and current recorded time (i.e., when message 250 was received) to determine a skew trend. The first processor 205 then calculates a correction to apply to its own time that includes the current difference in time between the processors (comparing the times of reception of 245 and 250) and skew trend. By applying this correction over the time period until the next messages are received, the processors will be adjusted to a synchronous state if the skew trend is consistent.

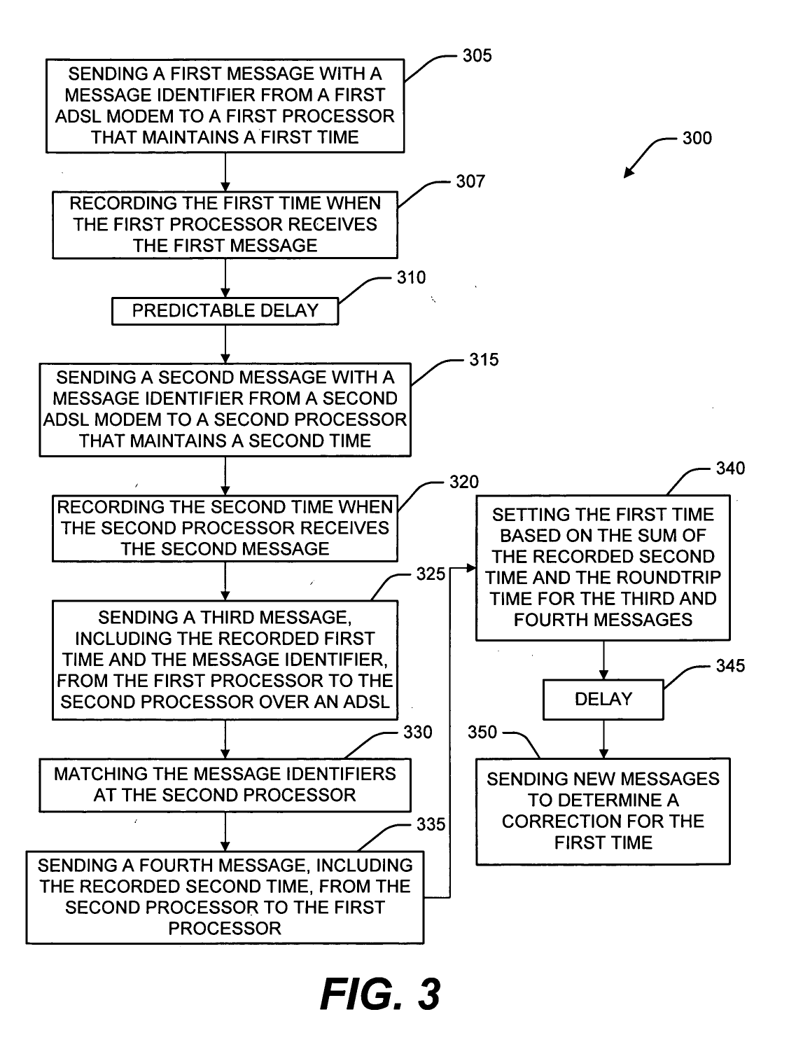

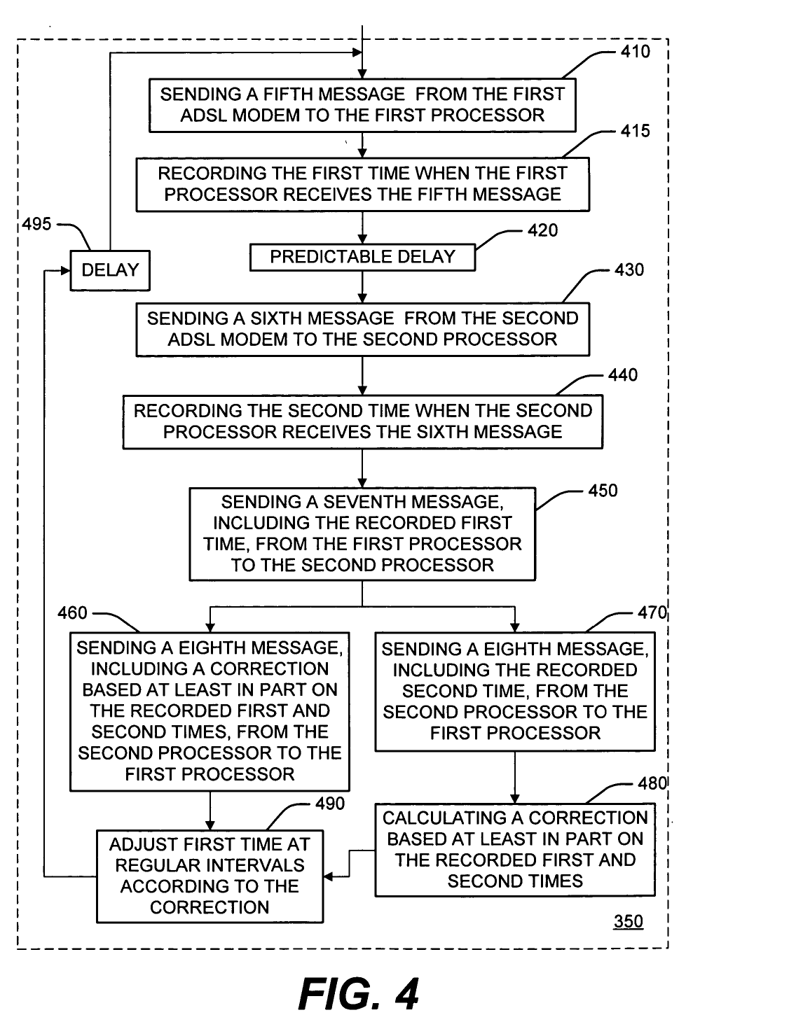

FIG. 3 is a flowchart to implement a method to adjust time settings according to one embodiment of the invention. At 305, a first message with a message identifier is sent from a first ADSL modem to a first processor that maintains a first time. A first time is recorded at 307 by the first processor when the first message is received. A predictable delay occurs at 310, e.g., a delay of less than 10 ms, before a second message with a message identifier is sent at 315 from a second ADSL modem to a second processor that maintains a second time. A second time is recorded at 320 by the second processor when the second message is received. A third message that includes the recorded first time and the message identifier is sent at 325 from the first processor to the second processor over the communications medium. The message identifiers at 330 are matched by the second processor. A fourth message including the recorded second time is sent at 335 from the second processor to the first processor. The time of the first processor is set at 340 based at least in part on the sum of the recorded second time and the roundtrip time for the inter-processor messages. At 345 a delay occurs. For example, a delay of a second may occur. After the delay, at 350, new messages are sent and used to determine a correction to be applied to the first time. FIG. 4 further describes step 350.

FIG. 4 is a flowchart to implement a method to adjust time settings according to one embodiment of the invention. Messages are exchanged at 350 between processors and a correction is applied to adjust the processor times. A fifth message is sent at 410 from the first ADSL modem to the first processor. A first time is recorded at 415 by the first processor when the fifth message is received. A predictable delay occurs at 420, before a sixth message is sent at 430 from the second ADSL modem to the second processor. A second time is recorded at 415 by the second processor when the sixth message is received. A seventh message that includes the recorded first time is sent at 450 from the first processor to the second processor. In one embodiment of the invention, an eighth message that includes the recorded second time is sent at 470 from the second processor to the first processor and a correction is calculated at 480 based at least in part on the recorded first and second times. In one embodiment of the invention, an eighth message that includes a correction based at least in part on the recorded first and second times is sent at 485 from the second processor to the first processor. The first time is then adjusted at 490 at regular intervals according to the correction. A delay occurs at 495 and another correction process can then begin. In one embodiment of the invention, one processor can be jammed with the time of the other processor several times before corrections are used. In another embodiment of the invention, times are jammed until the difference falls below a set level, at which point corrections are used.

The technical applications of this invention include wireline logging in which time settings of processors at the surface or in the wellbore are adjusted. The technical applications of this invention also include wireline logging in which time settings of processors in the wellbore of one well or in the wellbore of another well are adjusted. The technical applications of this invention also include process measurement and control in which time settings of processors at a sensor or in a control room are adjusted.

The foregoing description of the embodiments of the invention has been presented for the purposes of illustration and description. It is not intended to be exhaustive or to limit the invention to the precise form disclosed. Many modifications and variations are possible in light of the above teaching. For example, the time settings of processors located at the control room and remote sensors of a refinery can be set using the claimed method, software or system. In addition, the time settings of processors located downhole in different wells can be set using the claimed method, software or system. It is intended that the scope of the invention be limited not by this detailed description, but rather by the claims appended hereto.

1. A method of adjusting time recordation, comprising:
sending a first message to a first processor that maintains a first time;
sending a second message to a second processor that maintains a second time;
recording the first time when the first processor receives the first message;
recording the second time when the second processor receives the second message;
sending a third message from the first processor to the second processor;
sending a fourth message from the second processor to the first processor including information indicative of the recorded second time; and
setting the first time of the first processor based at least in part on the sum of the recorded second time and a roundtrip time for the third and fourth messages.

2. The method of claim 1 where the first processor and second processor are coupled by an asymmetric communication medium.

3. The method of claim 1 where the first processor and second processor are coupled by an asymmetric digital subscriber line.

4. The method of claim 1 where sending a first message to a first processor that maintains a first time and sending a second message to a second processor that maintains a second time are separated by a predictable amount of time.

5. The method of claim 1 where the third message includes an identification of the first message and further comprising:
upon receipt of the third message, matching the identification of the first message with an identification of the second message.

6. The method of claim 1, further comprising:
sending a fifth message to the first processor;
sending a sixth message to the second processor;
recording the first time when the first processor receives the fifth message;
recording the second time when the second processor receives the sixth message;
sending a seventh message from the first processor to the second processor including information indicative of the recorded first time; and
sending an eighth message from the second processor to the first processor including a correction based at least in part at least in part on the recorded first and second times.

7. The method of claim 1, further comprising:
sending a fifth message to the first processor;
sending a sixth message to the second processor;
recording the first time when the first processor receives the fifth message;
recording the second time when the second processor receives the sixth message;
sending a seventh message from the first processor to the second processor including information indicative of the recorded first time;
sending an eighth message from the second processor to the first processor including information indicative of the recorded second time; and
calculating a correction based at least in part at least in part on the recorded first and second times.

8. The method of claim 7 further comprising:
applying the correction to the first time a plurality of times at a regular interval.

9. The method of claim 1 where the first processor is located remotely from the second processor.

10. The method of claim 9 where the first processor is located in a wellbore and the second processor is located at the surface.

11. The method of claim 10 where the first processor is coupled by a network to a plurality of tools that send time-based measurements to the second processor.

12. The method of claim 1 where the roundtrip time for the third and fourth messages is an amount of time from the sending of the third message to the receipt of the fourth message.

13. A method of adjusting time recordation, comprising:
sending a first message to a first processor that maintains a first time;
sending a second message to a second processor that maintains a second time;
recording the first time when the first processor receives the first message;
recording the second time when the second processor receives the second message;
sending a fourth message from the second processor to the first processor including data based at least in part on the recorded second time; and
adjusting the first time based on a correction that is based at least in part on the data and the recorded first time.

14. The method of claim 13 where the data is the recorded second time.

15. The method of claim 13 where the data is equal to the correction.

16. The method of claim 13 where sending a first message to a first processor that maintains a first time and sending a second message to a second processor that maintains a second time are separated by a predictable amount of time.

17. The method of claim 13 where the fourth message includes an identification of the second message and further comprising:
upon receipt of the fourth message, matching the identification of the second message with an identification of the first message.

18. The method of claim 13 where the first processor and second processor are coupled by an asymmetric communication medium.

19. The method of claim 13 where the first processor and second processor are coupled by an asymmetric digital subscriber line.

20. The method of claim 13 where adjusting the first time occurs at regular intervals.

21. The method of claim 13 where the first processor is located remotely from the second processor.

22. The method of claim 21 where the first processor is located in a wellbore and the second processor is located at the surface.

23. The method of claim 22 where the first processor is coupled by a network to a plurality of tools that send time-based measurements to the second processor.

24. The method of claim 13 where adjusting the first time includes moving the first time forward or backward by an amount and, after a predetermined time, moving it forward or backward by the same amount again.

25. A computer program, stored on a tangible storage medium, for adjusting time recordation, the program including executable instructions that cause one or more computers to:
send a first message to a first processor that maintains a first time;
send a second message to a second processor that maintains a second time;
record the first time when the first processor receives the first message;
record the second time when the second processor receives the second message;
send a third message from the first processor to the second processor;
send a fourth message from the second processor to the first processor including information indicative of the recorded second time; and
set the first time of the first processor based at least in part on the sum of the recorded second time and the roundtrip time for the third and fourth messages.

26. The computer program of claim 25 where the first processor and second processor are coupled by an asymmetric communication medium.

27. The computer program of claim 25 where the first processor and second processor are coupled by an asymmetric digital subscriber line.

28. The computer program of claim 25 where the one or more computers are caused to send a first message to a first processor that maintains a first time and send a second message to a second processor that maintains a second time within a predictable amount of time.

29. The computer program of claim 25 where the third message includes an identification of the first message and further including executable instructions that cause one or more computers to:
upon receipt of the third message, match the identification of the first message with an identification of the second message.

30. The computer program of claim 25 further including executable instructions that cause one or more computers to:
send a fifth message to the first processor;
send a sixth message to the second processor;
record the first time when the first processor receives the fifth message;
record the second time when the second processor receives the sixth message;
send a seventh message from the first processor to the second processor including information indicative of the recorded first time; and
send an eighth message from the second processor to the first processor including a correction based at least in part on the recorded first and second times.

31. The computer program of claim 25 further including executable instructions that cause one or more computers to:
send a fifth message to the first processor;
send a sixth message to the second processor;
record the first time when the first processor receives the fifth message;
record the second time when the second processor receives the sixth message;
send a seventh message from the first processor to the second processor including information indicative of the recorded first time;
send an eighth message from the second processor to the first processor including information indicative of the recorded second time; and
calculate a correction based at least in part on the recorded first and second times.

32. The computer program of claim 31 further including executable instructions that cause one or more computers to:
apply the correction to the first time a plurality of times at a regular interval.

33. The computer program of claim 25 where the first processor is located remotely from the second processor.

34. The computer program of claim 33 where the first processor is located in a wellbore and the second processor is located at the surface.

35. The computer program of claim 34 where the first processor is coupled by a network to a plurality of tools that send time-based measurements to the second processor.

36. A computer program, stored on a tangible storage medium, for adjusting time recordation, the program including executable instructions that cause one or more computers to:
send a first message to a first processor that maintains a first time;
send a second message to a second processor that maintains a second time;
record the first time when the first processor receives the first message;
record the second time when the second processor receives the second message;
send a fourth message from the second processor to the first processor including data based at least in part on the recorded second time; and
adjust the first time based on a correction that is based at least in part on the data and the recorded first time.

37. The computer program of claim 36 where the data is the recorded second time.

38. The computer program of claim 36 where the data is equal to the correction.

39. The computer program of claim 36 where the one or more computers are caused to send a first message to a first processor that maintains a first time and send a second message to a second processor that maintains a second time within a predictable amount of time.

40. The computer program of claim 36 where the fourth message includes an identification of the second message and further including executable instructions that cause one or more computers to:
upon receipt of the fourth message, match an identification of the first message with the identification of the second message.

41. The computer program of claim 36 where the first processor and second processor are coupled by an asymmetric communication medium.

42. The computer program of claim 36 where the first processor and second processor are coupled by an asymmetric digital subscriber line.

43. The computer program of claim 36 where adjusting the first time occurs at regular intervals.

44. The computer program of claim 36 where the first processor is located remotely from the second processor.

45. The computer program of claim 44 where the first processor is located in a wellbore and the second processor is located at the surface.

46. The computer program of claim 45 where the first processor is coupled by a network to a plurality of tools that send time-based measurements to the second processor.

47. A system, comprising:
a first processor that maintains a first time;
a communication medium coupled to the first processor; and
a second processor that maintains a second time coupled to the communications medium;
where
the first processor is adapted to receive a first message;
the second processor is adapted to receive a second message;
the first time is recorded when the first processor receives the first message;
the second time is recorded when the second processor receives the second message;
the first processor is adapted to send a third message to the second processor;
the second processor is adapted to send a fourth message to the first processor including information indicative of the recorded second time; and
the first time is set based at least in part on the sum of the recorded second time and the roundtrip time for the third and fourth messages.

48. The system of claim 47 where the communication medium is asymmetric.

49. The system of claim 47 where the communication medium is an asymmetric digital subscriber line.

50. The system of claim 47 where the first and second messages are received a predictable amount of time apart.

51. The system of claim 47 where the third message includes an identification of the first message and the second processor is adapted to, upon receipt of the third message, match the identification of the first message with an identification of the second message.

52. The system of claim 47 where:
the first processor is adapted to receive a fifth message;
the second processor is adapted to receive a sixth message;
the first time is recorded when the first processor receives the fifth message;
the second time is recorded when the second processor receives the sixth message;
the first processor is adapted to send a seventh message to the second processor including information indicative of the recorded first time; and
the second processor is adapted to send an eighth message to the first processor including a correction based at least in part on the recorded first and second times.

53. The system of claim 47 where:
the first processor is adapted to receive a fifth message;
the second processor is adapted to receive a sixth message;
the first time is recorded when the first processor receives the fifth message;
the second time is recorded when the second processor receives the sixth message;
the first processor is adapted to send a seventh message to the second processor including information indicative of the recorded first time;
the second processor is adapted to send an eighth message to the first processor including information indicative of the recorded second time; and
the first processor is adapted to calculate a correction based at least in part on the recorded first and second times.

54. The system of claim 53 where:
the first processor applies the correction to the first time a plurality of times at a regular interval.

55. The system of claim 47 where the first processor is located remotely from the second processor.

56. The system of claim 55 where the first processor is located in a wellbore and the second processor is located at the surface.

57. The system of claim 56 where the first processor is coupled by a network to a plurality of tools that send time-based measurements to the second processor.

58. A system, comprising:
a first processor that maintains a first time;
a communication medium coupled to the first processor; and
a second processor that maintains a second time coupled to the communications medium;
where
the first processor is adapted to receive a first message;
the second processor is adapted to receive a second message;
the first time is recorded when the first processor receives the first message;
the second time is recorded when the second processor receives the second message;
the second processor is adapted to send a fourth message to the first processor including data based at least in part on the recorded second time; and
the first time is adjusted based on a correction that is based at least in part on the data and the recorded first time.

59. The computer system of claim 58 where the data is the recorded second time.

60. The computer system of claim 58 where the data is equal to the correction.

61. The computer system of claim 58 where the first and second messages are received a predictable amount of time apart.

62. The computer system of claim 58 where the fourth message includes an identification of the second message and the second processor is adapted to, upon receipt of the fourth message, match an identification of the first message with the identification of the second message.

63. The computer system of claim 58 where the communication medium is asymmetric.

64. The computer system of claim 58 where the communication medium is an asymmetric digital subscriber line.

65. The computer system of claim 58 where adjusting the first time occurs at regular intervals.

66. The computer system of claim 58 where the first processor is located remotely from the second processor.

67. The computer system of claim 66 where the first processor is located in a wellbore and the second processor is located at the surface.

68. The computer system of claim 67 where the first processor is coupled by a network to a plurality of tools that send time-based measurements to the second processor.
